(19) United States
(12) Patent Application Publication
(10) Pub. No.: US 2003/0130917 A1
(43) Pub. Date: Jul. 10, 2003

(54) Computer system for determining the risk index of a financial instrument and relevant method

(76) Inventor: Andrea Crovetto, Basiglio (IT)

Correspondence Address: Alan H. Levine, Howard F. Mandelbaum Levine & Mandelbaum, 444 Madison Avenue 35th Floor, New York, NY, 10022, US

(21) Appl. No.: 10/128,987

(22) Filed: Apr. 24, 2002

(30) Foreign Application Priority Data
Apr. 27, 2001 (IT) MI2001A000879
Mar. 12, 2002 (IT) TO2002A000209

(51) Int. Cl. G06F 17/60

(52) U.S. Cl. 705/35

(57) ABSTRACT

Computer system for determining and providing one or more users with a numerical index representative of the risk connected to an investment through a single financial instrument or a portfolio comprising several financial instruments, of the kind which comprises one or more computers connected in order to exchange data, said system implementing at least the following processing steps:

identifying the market factors and a calculation model to use for the calculation of prices for the instrument or instruments which form the portfolio;

collecting the historical values of the market factors observed during the latest h periods;

revaluating the instrument or portfolio on the basis of the set of data regarding the h periods and calculating profits and losses as to the instrument or portfolio current value;

arranging the economic results starting from the highest net profit to the highest loss;

identifying the loss which is exceeded in a percentage of cases, particularly in 1% cases.

According to the invention, said one or more computers comprise a data collection and management system (TSI), a calculation engine (KE) for said risk index and one or more distribution systems.

### DESCRIPTION

The invention relates to a computer system for determining a numerical index representative of the risk connected to an investment through a single financial instrument or a portfolio comprising several financial instruments, of the kind which comprises one or more computers connected in order to exchange data.

The investment in financial instruments (shares, funds, stock, etc.) by single investors and companies is greatly hindered by the difficulty in quantifying the risk of the several financial instruments in a consistent way, in order to compare different shares, and choose and perhaps modify the portfolio.

Risk awareness is an essential factor when choosing an investment, and most investors are now familiar with the notion that higher earnings imply higher risks.

It is also known that the idea of higher risk is linked to a higher variability of the expected earnings.

Nevertheless it is still difficult to attach a tangible meaning to these general ideas, particularly for the individual investor.

To encourage the investors, brokers have defined qualitative categories on the basis of risk propensity (investment profiles). This normally requires a questionnaire or an interview which aims at fixing the objectives and the time horizon of the investment so as to identify the suitable financial instruments.

Even if this way it is generally possible to ascertain if the investor has a low, medium or high risk propensity, it is still impossible to communicate to the common investor what the classification entails in financial and objective terms of possible earnings related to possible losses.

So the investor is now unable to determine a risk/earnings ratio in an objective and reliable way for the different financial instruments in order to decide if it is acceptable.

The U.S. Pat. No. 5,991,743 document describes a system and method for controlling the exposure risk for bank debts for several users, and it suggests some models to calculate risk and distribution conditions.

The U.S. Pat. No. 6,078,903 document relates to a method for modeling the loan related risk.

The U.S. Pat. No. 6,119,103 document describes a system of prediction of credit risk, also with regard to the notion of portfolio.

The U.S. Pat. No. 6,085,175 document describes a system and method for determining the value at risk of a financial portfolio.

The present invention has therefore the object of overcoming the limitations of computer systems and relevant previous methods, and particularly of proposing a computer system and a method for the calculation or determination of a simple and plain risk index, suited to make available to the holders the knowledge of an effective risk index, easily and quickly, either for a single financial instrument or for a portfolio comprising various instruments.

The risk indicator calculated and distributed by the computer system according to the invention is expressed in terms of highest loss (per cent, or, in any case, referring to the extent of the investment) in the space of a day. More particularly, it offers a statistical measurement which is able to quantify the floating of the value of a portfolio (in gain or loss) in a given period of time and with a certain confidence interval, for example a 99% confidence interval, that is a 1% percentage of cases.

Moreover, the object of the risk indicator calculated and distributed by the system according to the invention is to make objective the comparison between the level of risk connected to the invested portfolio and the level of risk propensity of the investor, defined through an evaluation form that he usually fills or through an interview, by request of the broker.

Further, it is an object of the present invention to supply a fast distribution and interfacing system, suitable and controlled, endowed with access modes suitable for various types of users.

The present invention will be better understood and appreciated in its entirety through the following detailed description of the preferred, but not limiting, embodiments, to be considered together with the enclosed drawings, where:

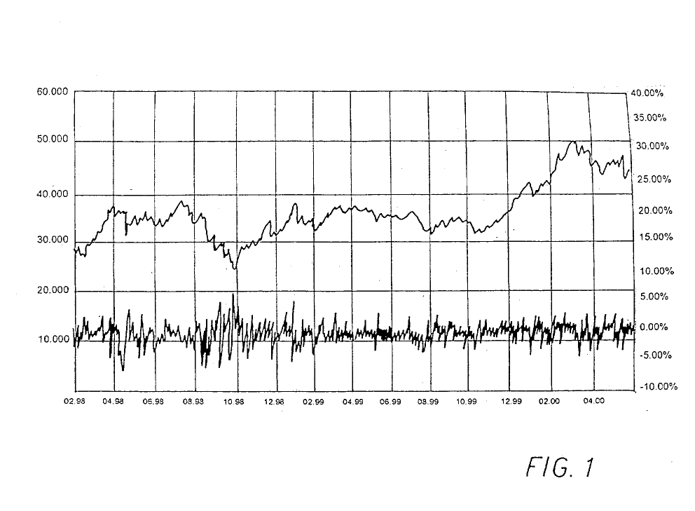

FIG. 1 shows the trend in time of a financial instrument, with the object of explaining the features and methods for determining the index according to the invention;

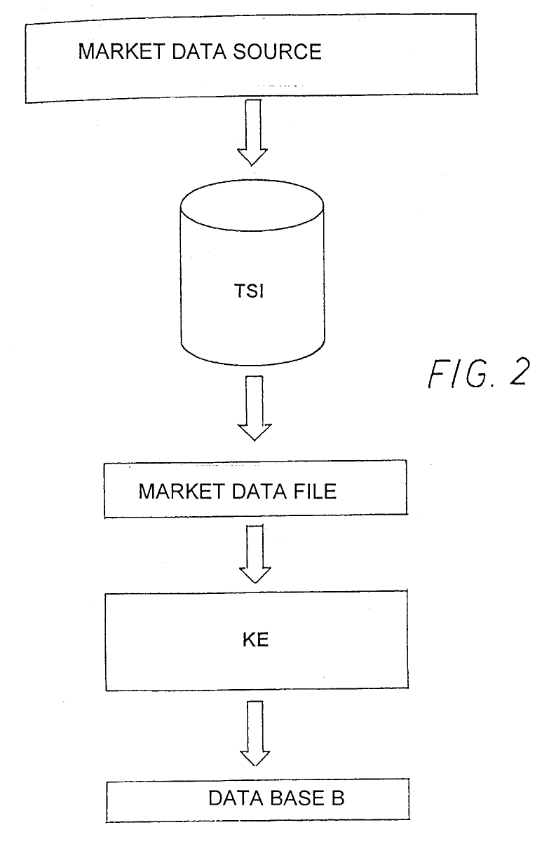

FIG. 2 shows the essential composition of the system according to the invention;

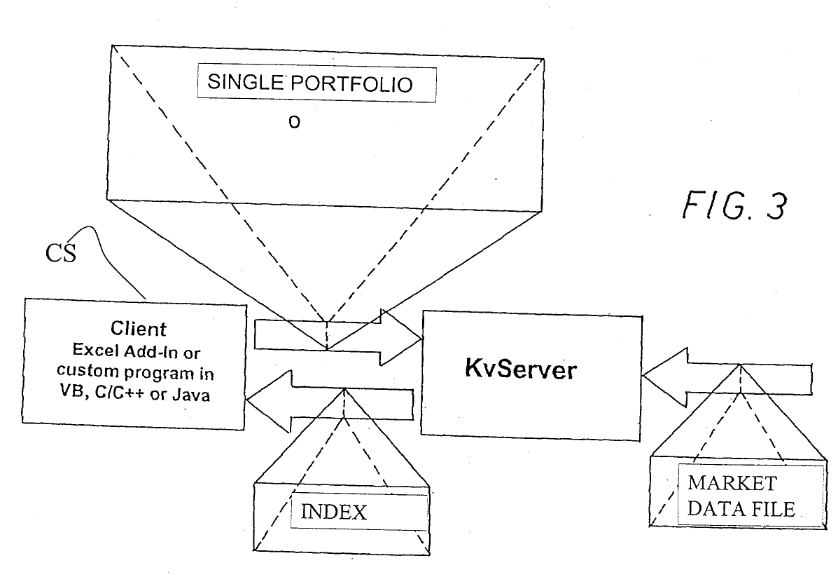

FIG. 3 shows, more in detail, the device that calculates the risk index;

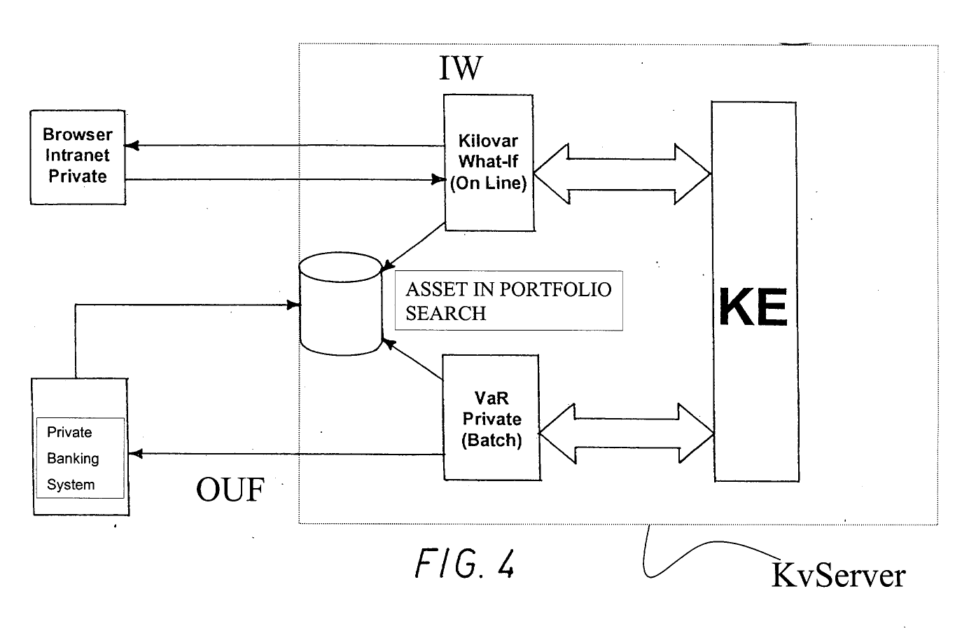

FIG. 4 shows the structure and the connections for using the method through the Internet; and

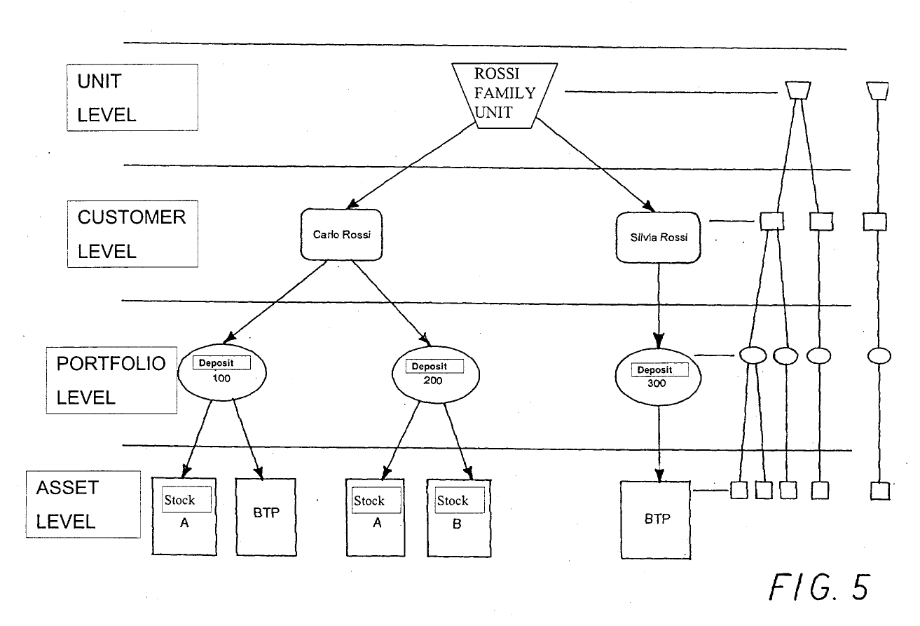

FIG. 5 shows the calculation of the risk index on several levels for a single customers unit, particularly a family unit;

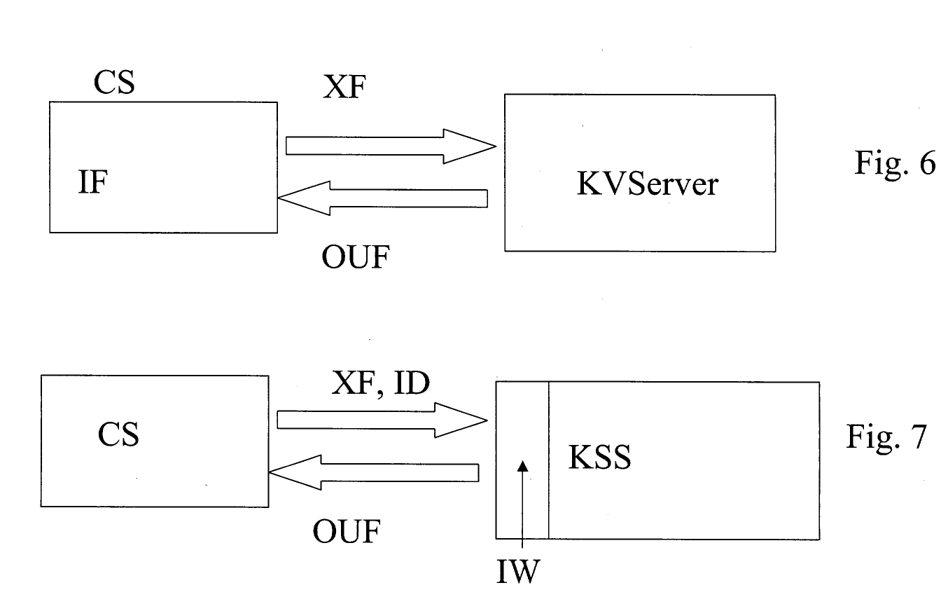

FIG. 6 shows a means of access to the computer system which implements the method according to the invention;

FIG. 7 shows a further means of access to the computer system which implements the method according to the invention;

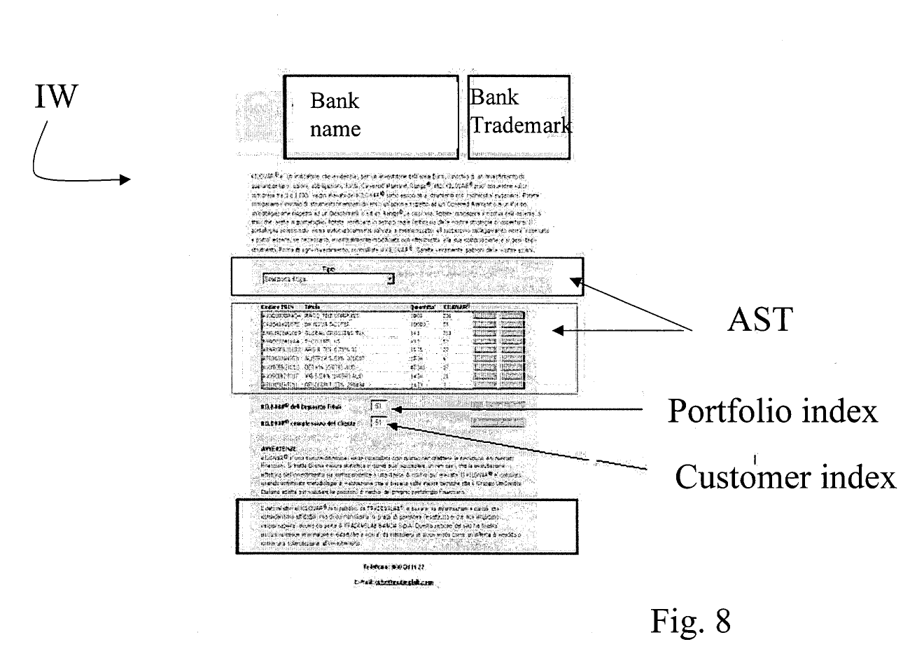

FIG. 8 shows an example of display mask concerning the means of access shown in FIG. 7.

In FIG. 1, the lower graph shows the trend in time of the value of a financial instrument (share, bond, fund, covered warrant, stock index, etc.), and the upper graph shows the percentage variations of a stock index. In more generic terms, the graphs could relate to value indexes, for example MIB 30 or the Nasdaq index, and their fluctuations.

A numerical index is determined through the computer system and method according to the invention, which represents the so called VaR (Value at Risk) of the considered financial instrument.

FIG. 1 exemplifies how the daily trading limit in the period taken into account is 5%, which amounts to a 50 units loss against a 1000 units investment, in case the investor—on that particular day—was going against the market, for example by selling his stock. In FIG. 1 the graphs stretch on a 2 years period, but the representative samples of possible future movements are actually the more recent ones, therefore the time window on which the analysis is carried out is narrower; it is generally of about 1 year. In this case the index is 50 out of 1000, or 50/1000.

This is a statistical measurement based on a dynamic data sample, so the index varies in time.

Referring to FIG. 2, the essential composition of the computer system according to the invention consists of three items:

a data collection and management system (data source);

the calculation engine for the risk index (KE);

the distribution systems.

The data collection and management system contains a collection of the historical series of financial variables, regarding a wide range of instruments.

The types of market data collected are, for example, prices and rates which directly constitute the risk factors, including:

swap rates;

money market rates;

government bonds rates;

exchange rates;

quotations of the main stock exchanges indexes;

share trends;

futures and options on rates, government bonds, stock indexes and currencies.

Preferably, prices and rates are processed in order to obtain data which are implied in the price of some derivative instruments, as:

caps volatility and rates floor;

OTC options on exchange rates;

options on futures on government bonds, indexes and shares.

The data collection by the data collection and management system occurs synchronically (snapshot) only once a day, for example at local time 5.00 PM.

Even if the closing data concerning the markets are easily available, the snapshot mode has been preferred so as to avoid fictitious fluctuations due to different closing times. Immediately after their collection, data are subjected to the basic post-processing operations required for the calculation of the average Bid-Ask spread. If this is not possible, in the RMG application are introduced, in the following order:

the last available value for the day (last price);

the Bid price;

the Ask price;

the value of the previous day.

In this way the historical series are obtained for every market parameter and the Zero Yield Curves are calculated. Prices collected by options and caps/floors are subsequently processed in order to build the implicit volatility curves. The “cheapest to deliver” for futures on government bonds is then calculated.

Therefore, the component indicated with TSI in FIG. 2 constitutes the historical series database collecting the market data and it feeds directly on information providers, via a sink distributor.

The historicization of market data allows the use of historic simulation, selected method for the calculation of the risk index according to the invention. The device KE, shown in FIG. 2, is a calculation engine comprised inside a server Kvserver, which is shown in FIG. 3, that performs the proper calculation of the risk index. In terms of data processing, the system is implemented on a Windows NT platform and it is based on a complete pricing library and the calculation of the financial instruments in portfolio. The basic functions of the library—which implement the more complex algorithms—are written, preferably, in C++ programming language and are available in DLL (Dynamic Loaded Library) format. To be more precise, the Kvserver containing the calculation engine KE receives the market data files, as shown in FIG. 3, and it is connected to a client server CS which comprises a specific program (custom in C/C++, VB or Java, or an Excel based add-in) and can receive and manage a lot of queries concerning both single financial instruments and variously shaped portfolios. FIG. 3 shows the case of a single asset or portfolio, sent to the server Kvserver, which returns the risk index.

The application program for the calculation of the risk index resides on the disks of the NT system and it is protected by a password, with an authorization system that only allows access to given users, and/or on predetermined machines. Moreover, all programs are protected and cannot be modified.

According to an important feature of the computer system and relevant method according to the invention, it is possible to calculate the risk index whether related to a single share or to a stock portfolio, since only reasoning in terms of a portfolio constitutes a correct decision support.

Three different typologies of processing are possible:

calculation of the index of single financial instruments (single asset);

periodic calculation of the index of assigned portfolios in batch and on-demand mode;

interactive calculation of the index on application of the users in an on-demand mode.

With regard to the first mode, the index of the single assets present on the server Kvserver is calculated on a daily basis, and it therefore feeds on the data base B, which is of historical type (cf. FIG. 2). So it is possible to analyze the index evolution in time, the reason why the index increases its weight as a decision instrument in terms of asset allocation and risk control.

The data base B is updated not only by adding the new calculations on a daily basis, but also by retroactively modifying the individual data with regard to corporate events like splits or stock clusters, extraordinary dividends, mergers and amalgamations which can modify the share character, in order to guarantee the homogeneity, and consequently the comparability of the historical series.

According to the method implemented in the system according to the invention, the main risk factors which determine the value variations of a generic financial product are taken into account for the calculation of the risk index. Essentially, these factors are:

interest risk on the term structure of rates;

basic risk;

credit risk or issuer risk (credit spread);

stock risk;

exchange risk;

liquidity risk;

linear price risk (delta);

non linear price risk (gamma);

volatility risk;

risk of changes in volatility (vega);

interest risk (rho).

Non linear risks of an order higher than the second, whose order of magnitude which is marginal as regards the considered risks, have not been taken into account. Nevertheless, the method can be extended to cover also these risks, in case given products generated significant dependence on the excluded risk factors.

As said, the method according to the invention provides for an approach which can be defined of “historical simulation”, requiring few hypotheses about the statistical distributions of the market factors involved.

According to this approach, a distribution of rates of return (profits and losses) of a financial instruments portfolio is constructed by using the historical variations of market prices. This distribution is constructed starting from the present portfolio and subjecting it to revaluation on the basis of the actual variations of market factors, which take part in the formation of prices of the individual instrument, and which have been observed in the latest h periods (days). The h revaluations are compared with the current value of the portfolio, and the hypothetical profit or loss is calculated for each one.

The historical simulation includes the following five stepss:

1. Identification of the market factors and of the calculation model to use for calculating the prices of the instruments which form the portfolio.

2. Collection of the historical values of the market factors observed in the latest h periods.

3. Revaluation of the portfolio on the basis of the set of data regarding the h days and calculation of profits and losses as to the portfolio current value.

4. Arrangement of the economic results starting from the highest net profit to the highest loss.

5. Individuation of the loss which is exceeded in a percentage of cases, in the preferred embodiment a percentage of 1%.

In case the method is applied to a portfolio of different financial instruments, step 4 must be preceded by the calculation of the cumulative economic result, and only later the results of the single h days are put in order. In the process, the correlation among the different instruments and the degree of diversification of the portfolio is allowed for. As a rule, the value of a portfolio is a function of a set of N risk factors which can be, for example, values of market variables.

The value of the portfolio is therefore expressed by:

Π=ƒ(S₁, S₂, . . . , S_{N}) (1)

wherein Si is the i-eth risk factor and the function f is the sum over various positions which are themselves function of the risk factors. Having N series of the historical variations for each risk factor, each one composed of h elements, assuming these relative variations are representative of possible future variations, a future series is constructed, derived from today's spot prices.

For the k-eth risk factor, the r-eth relative variation generates a hypothetical value of the risk factor indicated by S^{r}ₖ. The value of the corresponding portfolio is calculated as follows:

$${Π}_{r} = f ( {S}_{i1}^{r} , {S}_{2}^{r} , … , {S}_{N}^{r} ) r = 1 … h \qquad ( 2 )$$

The corresponding fluctuations of the value of the portfolio are calculated in accordance with the following expression:

ΔΠᵣ=Πᵣ−Πr=1 . . . h (3)

wherein Π is calculated as previously described. This process leads to the generation of a series of h samples. The empirical distribution of the quantity under consideration (in this case, ΔΠ) being available, it is possible to approximate the percentage corresponding to the confidence level without limits on the analytic form of the distribution. The above described process is based on the full-revaluation method, inasmuch as it is assumed that the function determining the value of the portfolio is available and can be revaluated according to the specified parameters if necessary.

However, in case said function is not available on the risk management system or if it takes too much time to recalculate it, it is possible to use the partial revaluation resorting to the Taylor series expansion of the equation (4) in the following fashion:

$$Δ Π = {\sum }_{i = 1}^{N} \frac{\partial Π}{\partial {S}_{i}} Δ {S}_{i} + \frac{1}{2} {\sum }_{i , j = 1}^{N} \frac{{\partial }^{2} Π}{\partial {S}_{i} \partial {S}_{j}} Δ {S}_{i} Δ {S}_{j} + O ( Δ {S}^{3} ) \qquad ( 4 )$$

wherein ΔΠ is the fluctuation expected in the portfolio value (the subscript r is omitted for the sake of simplicity); ΔSᵢ; is the expected fluctuation of the i-eth risk factor; and O(ΔSᵢ) is used to indicate terms of the third order or higher. From a theoretical point of view there is no differentiation among different risk factors. Farther on in this discussion, anyway, we will distinguish risk factors directly ascribable to listed prices from those which represent their volatility.

We define:

δ (delta) the vector of the partial derivatives of the first order with respect to the risk factors directly ascribable to prices or rates;

γ (gamma) the matrix of the second partial derivatives (Hessian matrix) with respect to the same risk factors;

υ (vega) the vector of the first order partial derivatives with respect to the risk factors which represent the prices or rates volatility.

Moreover, it is assumed that the second order terms with respect to volatility are of the same order of the third order terms with respect to prices. The definitions just shown allow to rewrite the equation (5) in a more concise form:

$$Δ Π = {\sum }_{i = 1}^{N} {δ}_{i} Δ {S}_{i} {+ \sum }_{i = 1}^{N} {υ}_{i} Δ {σ}_{i} + \frac{1}{2} {\sum }_{i , j = 1}^{N} {γ}_{i} Δ {S}_{i} Δ {S}_{j} + O ( Δ {S}^{3} ) \qquad ( 5 )$$

wherein Δσᵢ is the volatility variation of the i-eth risk factor. The relationship underlines the advantages of the partial-revaluation approach with the historical simulation. They can be summarized as follows:

Once (δ, γ, υ) of the portfolio and the expected fluctuations of the risk factors are known, the calculation of the value fluctuation distribution of the portfolio is done through a simple algebraic operation.

The consideration of the terms of volatility and of second order in Taylor series produces a qualitatively higher estimate of a risk index compared to the usually adopted delta-normal method, regardless of every consideration about the analytic form of the risk factors fluctuations distribution.

No restrictions are imposed regarding the linear independence of the series, consequently the number of risk factors comprised in the simulation can be high at the discretion of the risk manager.

In deriving the concise Equation (5) the following hypotheses have been used:

The Taylor approximation stands up for small perturbations of the risk factors, and when the non linearity of the portfolio is moderate. So it can become inaccurate faced with considerable market variations, when a full revaluation technique becomes necessary.

The historical period of reference is necessarily short, in the order of a few hundreds of daily observations. Even when series of greater historical depth are available, it is not reasonable to assume they are indicative in the simulation of the current market conditions. Consequently, the statistics of the portfolio value fluctuations is not particularly rich.

In case of market shocks, the consequences have more repercussions on the calculation of the risk index than by applying other techniques. Practically, the risk index according to the invention is much more reactive to sharp market movements, which remain “memorized” with equal intensity until they appear in the observation period.

The decision to invest in financial instruments is preferably based on the analysis of the risk and yield pair, as shown, for example, by Markovitz.

The risk and yield integrated analysis is complex because, even if the expected yield is easy to understand and communicate, risk is an obvious notion, but it is difficult to quantify.

The risk index determined and distributed by means of the system and method according to the invention represents a measurement mechanism which has the control of the degree of risk for the investor as its first objective, but is also a decision instrument for the portfolio allocation. For example, it can be used by investors to limit their portfolio riskiness, creating a cover against risk; a risk level is fixed, then instruments suited to reduce risk are chosen, typically appropriate covered warrants. The calculation method is one of general nature, therefore suitable for every use and addressee, but the main addressee is a public of individual private investors (retail investors) lacking in the sophisticated risk determination instruments used by professional traders.

The calculated index can be distributed and then communicated to the investors in four ways: through publication on Internet/Intranet sites, informative publications, periodical communications to the customers, the network of agencies, private bankers and promoters (even inside their applications).

The Internet site allows to communicate the index to the user who requested it in the fastest and most widespread way, but most of all it allows to conduct analyses in an interactive way, because the investor can directly modify the composition of his own portfolio, simulating its behavior and the degree of risk (with an analysis of the “what if” kind) . Typically, the investor creates his portfolio on the site by means of two menus: with the first, he selects the instrument type; with the second, a security belonging to the category shown. Further details of this mode will be given with reference to FIG. 8.

From a data processing point of view, this requires a connection between the site and the server KvServer containing the engine KE in on-demand mode.

FIG. 4 shows the above described structure and connection, consisting of a browser, belonging to a private person or to an Intranet, that gains access, through a Web IW interface also called Kilovar What-if, to the calculation engine KE contained in the server KvServer. The IW Kilovar What-if interface gains access to the TSI data base for the search of Assets in portfolio.

The second mode provides for the diffusion through a network of promoters and financial consultants. With this channel the portfolio held by the investor is registered, so the index risk of the portfolio can be calculated on a periodical basis, typically on a daily basis. In this way the risks assumed by the customer are continually controlled, offering the customer a constant control service. To the periodical calculation in batch mode, also in this case can be associated an on-demand query which allows to verify the effect of modifications to the portfolio. In this instance, the query does not take place through an Internet site but through the promoters and financial consultants Intranet or through other applications.

FIG. 4 exemplifies the implementation of the Batch mode, in which one can gain direct access to the assets in the data base from a Private Banking client, as it can be done in the course of the execution of the batch program, which feeds the calculation engine KE.

Investors assisted by promoters and financial consultants often own several security deposits and, more generally, different people, each of them holder of different security deposits, are referable to one unit, for example a family unit. In this case, according to the invention, the risk index can be calculated on several levels, as shown with reference to FIG. 5, namely on a single asset level, on a portfolio level, on an individual investor level, on a unit level.

It is clear that the possibility of a risk index calculated on several levels, as exemplified in FIG. 5, particularly on a single asset level and on a portfolio level, as well as the above mentioned possibility to conduct analyses in an interactive way, directly modifying the portfolio composition and simulating its behavior and risk degree, entails the support of different access modes and communication among providers, particularly, for example, the applicant TRADINGLAB®, and the user (bank, Internet site, means of communication).

The way the piece of information about the risk index between a client server CS and the server KvServer was extracted, has been described in general terms in FIG. 3, while the access and batch modes to the server KvServer and to the calculation engine KE of the risk index have been described in FIG. 4.

In FIGS. 6, 7, and 8, the access modes to the calculation engine KE are further detailed.

Actually, in the case of evaluations of the risk index as a single financial instrument, in order to receive the risk index associated to each instrument, the user must establish a connection with a FTP server, which can partly or entirely correspond to the server KvServer described in FIG. 3 and in FIG. 4, operating with the provider, where the file containing all the updated values of the risk index can be collected.

The list of the instruments contained in the file is defined by the provider together with the user.

In case of average users it is therefore required to gain access to said FTP server. Normally, this kind of connection does not require special developments and can be accomplished through several applications available on the market.

The initial connection process for the activation of the service occurs as follows:

the user notifies the provider the IP address/addresses with which he wants to gain access;

arrangement of a customized file on the part of the provider;

the provider notifies the user his username and password;

connection test;

entering production.

The customized file contains information for each security in a format arranged with the user.

In case of evaluations of the risk index as a portfolio instrument, the requests for calculation of the portfolio risk index, as shown in FIG. 6, must be submitted to the server KvServer through a XF file (currently in XML language) compatible with the different technologies typically adopted by the bank customers.

Through the connection with the server KvServer, the user (bank, SIM) receives the risk index of his customers' portfolios, both for each securities deposit and for aggregate portfolios. The output consists of an output file OUF, that is the same XF file which is sent to the provider, completed with the risk index values. The user acknowledges said output file OUF in a Proprietary Interface IF for the display of the datum residing on his client server CS; it is also possible to operate in a WEB IW interface, similar to the one used for the Simulation Server KSS that will be illustrated further on, and to the WEB IW interface model shown in FIG. 8.

With the present method, the development of an application operating on the client server CS can therefore be required to the user, supporting the following activities:

connection to the Server KvServer;

compilation of the XF file through extraction of data from the database concerning the securities deposit.

In case of development of a proprietary application for the communication of the risk index values KILOVAR®, the following steps are taken:

reading of the file OUF that is returned by the provider with the value of the risk index of the single securities and of the portfolio;

development of the IF Proprietary Interface or insertion inside the already developed application.

In case of adoption of the interface developed by the provider, these are the next steps to take:

interface customization;

insertion of an access to the interface inside the applications of reference of the financial consultants.

The calculation of the portfolio risk index can be performed, as already exemplified with reference to FIG. 4 for the single asset:

on demand, for example in the direct relationship between consultant and customer;

in batch mode, for example in order to insert the risk index in the periodical bank statement.

The connection through XF file in XML language is extremely versatile. It actually allows to calculate the risk index for every single security, for every single deposit of securities, and every group of security deposits belonging to a single customer.

In case of evaluations of the risk index as a simulation of the portfolio risk index in order to conduct analyses in an interactive way, directly modifying the composition of the portfolio itself, the user (FIG. 7) can link up a Simulation Server (KSS), which is a variant to the server KvServer of FIG. 6, and represents a web site in which, starting from the portfolio owned by an investor, it is possible to simulate direct buy and sell operations on demand. This type of connection has been designed in order to make the development activity of technological infrastructures easier and shorter for the user.

The user, through a unique identity code ID, gains access to a web page resident on the server KSS, on which:

the portfolio of a single customer is displayed to make the simulations faster;

it is possible to see another portfolio of the customer, if present.

The request for calculation can be performed on demand or in batch mode. The XF request file is similar in both modes.

The server KSS receives the XF request file and processes it, in the meantime verifying the identity code ID. Then the server KSS calculates the risk index for every security and every portfolio and adds it to the output file OUF, which is then sent to the customer.

The selection of the securities in the Web interface, exemplified in FIG. 8, is made hierarchically on four levels in a security selection area AST:

type, for example shares, bonds, warrants, funds;

subtype, for example in the case of corporate bonds, convertible bonds, emerging markets;

search key: for identifying the security in the subtype, for example, in the case of corporate bonds, the issuers list;

single securities, for example bonds issued by the same company.

The user can develop an interface or he can use the IW interface developed by the provider. It is a html page, as exemplified in FIG. 8, that the user can customize, for example, with his logo and banners, but it keeps the security selection area AST and a reference to the portfolio index and a reference to the customer index which are updated after operating on the security selection area AST.

The risk indicator determined through the computer system and relevant method according to the invention has also the object of making the comparison between the risk level connected to the invested portfolio and the level of risk propensity of the investor or user objective; the risk level is defined by several methods, like an evaluation questionnaire or an interview that, typically, the user fills or gives at the request of the broker of reference. According to a feature of the invention, to each investment profile is associated an interval of values assumed by the risk indicator determined and provided through the system and method according to the invention. Said investment profile is also called risk class.

The extremes for each of said risk classes can be subject to variations in time as a response to changes concerning the market, and therefore the determination of the risk measurement.

The user, then, is offered a representation of said risk classes, for example on the IW interface, for example in the form of a scale based on the risk index values intervals. In this way the user can verify if his portfolio choices correspond to the desired risk class.

Although the invention has been illustrated with reference to favorite embodiments, it is generally susceptible of other realizations and changes intended as comprised in the protection scope, as it will appear .obvious to the expert in this field.

1. Computer system for determining a numerical index representative of the risk connected to an investment through a single financial instrument or a portfolio comprising several financial instruments and for providing one or several users with said index, of the kind which comprises one or more computers connected in order to exchange data, said conmputer system implementing at least the following processing steps:
identifying the market factors and a calculation model to use for the calculation of prices of the instrument or instruments forming the portfolio;
collecting the historical values of market factors observed during the latest h periods;
revaluating the instrument or portfolio on the basis of the set of data regarding the h periods and calculating profits and losses as to the instrument or portfolio current value;
arranging the economic results starting from the highest net profit to the highest loss;
identifying the loss which is exceeded in a percentage of cases, particularly in 1% cases; characterized by the fact that said one or more computers comprise a data collection and management system (TSI), a calculation engine (KE) of said risk index and one or more distribution systems of said risk index.

2. Method for determining a numerical index representative of the risk connected to an investment through a single financial instrument or a portfolio comprising several financial instruments, of the kind requiring the use of a computers system for determining said numerical index implementing a procedure of historical simulation characterized by the following steps:
identifying the market factors and a calculation model to use for the calculation of prices of the instrument or instruments forming the portfolio;
collecting the historical values of market factors observed during the latest h periods;
revaluating the instrument or portfolio on the basis of the set of data regarding the h periods and calculating profits and losses as to the instrument or portfolio current value;
arranging the economic results starting from the highest net profit to the highest loss;
identifying the loss which is exceeded in a percentage of cases, particularly in 1% cases.

3. Method according claim 2, wherein said financial instrument is constituted by one security and does not contemplate the arrangement stage.

4. Method according to claim 2, wherein said financial instrument is constituted by a securities portfolio.

5. Method according to claim 2, wherein said periods are equivalent to days.

6. Method according to claim 2, wherein said data collection occurs synchronically only once a day.

7. Method of the previous claims, wherein the historicization of market data and the use of historical simulation for the calculation of the risk index is contemplated.

8. Method according to claims 2 to 6, wherein said index is calculated periodically for assigned portfolios in batch mode.

9. Method according to claims 2 to 6, wherein said index is calculated interactively on application of a user in an on-demand mode.

10. Method according to the previous claims, wherein linear risks of the first order and price risk are taken into account for the calculation of said risk index.

11. Method according to claim 10, wherein said risks comprise one or more of the following:
linear price risk; interest risk on the forward structure of rates; basis risk; credit risk or issuer risk; stock risk; exchange risk; non linear price risk; risk of changes in volatility; interest risk; time related risk.

12. Method according to the previous claims, wherein the calculation on several levels is contemplated: single security, portfolio, single investor, unit (for different people, each of them holder of different security deposits, referable to one family unit).

13. Computer system implementing the method according to claim 2 and following, of the kind comprising one or more computers connected in order to exchange data wherein said one or more computers comprise a data collection and management system (TSI), a calculation engine (KE) for the risk index, and one or more distribution systems.

14. Computer system according to claim 13, wherein said data collection and management system (TSI) contains a collection of the historical series of financial variables.

15. Computer system according to claim 13, wherein said historical series of financial variables comprise prices and rates which constitute the risk factors, particularly swap rates and/or money market rates and/or government bonds rates and/or exchange rates and/or quotations of the main stock exchanges indexes and/or share trends and/or futures and options on rates, government bonds, stock indexes and currencies.

16. Computer system according to claim 15, wherein said prices and rates are processed in the data collection and management system (TSI) in order to obtain derivative instruments, particularly OTC options on exchange rates and/or caps volatility and rates floor and/or options on futures on government bonds, indexes and shares.

17. Computer system according to claim 13, wherein said data collection and management system (TSI) collects data synchronically only once a day.

18. Computer system according to claim 13, wherein said data collection and management system (TSI) processes the historical series of financial variables through a series of post-processing operations comprising, in particular, the calculation of the average Bid-Ask spread.

19. Computer system according to claim 13, wherein said data collection and management system (TSI) receives information from the information providers, via a sink distributor.

20. Computer system according to claim 13, wherein the calculation engine (RE) analyzes the risk index using the historical data.

21. Computer system according to claim 20, wherein said calculation engine (RE) is implemented through a computer comprising a library for pricing and calculating the financial instruments.

22. Computer system according to claim 21, wherein said computer is a server (KvServer) containing the market data files, said server (KvServer) being connected to a client server (CS) in order to manage queries concerning single financial instruments and/or portfolios.

23. Computer system according to claim 22, wherein said server (KvServer) contains the application program for the calculation of the risk index.

24. Computer system according to claim 13, wherein said system also comprises a data base (B) which feeds on data from said calculation engine (KE) in order to build historical collections.

25. Computer system according to claims 13 and 22, wherein said data base (B) and said calculation engine (KE) are implemented in the server (KvServer).

26. Computer system according to claim 22, wherein said server (KvServer) is connected to a client server (CS) in order to manage queries concerning single financial instruments and/or portfolios, which are sent through a special request file (XF).

27. Computer system according to claim 26, wherein said server (KvServer) provides the client server (CS) with the indexes as an answer to the queries concerning single financial instruments and/or portfolios, in a output file (OUF) which incorporates the request file (XF).

28. Computer system according to claim 27, wherein the client server (CS) has a proprietary interface to display said output file (OUF).

29. Computer system according to claims 13 and 22, wherein the distribution system is also accomplished through a Internet/Intranet site.

30. Computer system according to claim 29, wherein said server (KvServer) is a simulation server (KSS), comprising a Web interface (IW).

31. Computer system according to claim 29, wherein said Web interface (IW) provides for a security selection area AST, hierarchically arranged on at least four levels, particularly: type; subtype; search key; single securities.

32. Computer system according to claim 13, wherein the distribution system is accomplished through a Internet and/or Intranet network, particularly a banking network or a financial company network.

33. Computer system of one or more previous claims, wherein the distribution system provides for identifying and presenting intervals of numerical values assumed by the risk index (risk classes), variable in time as a response to changes in the market, associable to qualitative profiles of risk propensity (investment profiles) for investors and/or units.

34. Computers system for determining a numerical index representative of the risk connected to an investment through a single financial instrument or a portfolio comprising several financial instruments and for providing one or more users with said index, of the kind which comprises one or more computers connected in order to exchange data, wherein said computers system comprises a distribution system which provides for identifying and presenting intervals of numerical values assumed by the risk index (risk classes), variable in time as a response to changes in the market, associable to qualitative profiles of risk propensity (investment profiles) for investors and/or units.
